(19) United States
(12) Patent Application Publication
(10) Pub. No.: US 2011/0043633 A1
(43) Pub. Date: Feb. 24, 2011

(54) Use of a Single Camera for Multiple Driver Assistance Services, Park Aid, Hitch Aid and Liftgate Protection

(76) Inventors: Guner R. Sarioglu, Oakland Township, MI (US); John T. Hargenrader, Brighton, MI (US); Matthew T. Burtch, Concord, CA (US)

Correspondence Address: MAGNA INTERNATIONAL, INC., 337 MAGNA DRIVE, AURORA, ON, L4G-7K1, CA

(21) Appl. No.: 12/812,828

(22) PCT Filed: Jan. 21, 2009
(86) PCT No.: PCT/CA2009/000081

§ 371 Date: Nov. 8, 2010

Related U.S. Application Data
(60) Provisional application No. 61/011,795, filed on Jan. 22, 2008.

(51) Int. Cl. H04N 7/18

(52) U.S. Cl. 348/148; 348/E07.085

(57) ABSTRACT

The present invention is a system for providing multiple driver assistance services which includes a vehicle having at least one door, and at least one imaging device operable for detecting the presence of one or more objects in proximity to the door for providing all distances between a vehicle and one or more objects in proximity to the vehicle. The imaging device is operable for displaying an image representing the various objects.

### CROSS-REFERENCE TO RELATED APPLICATION

The instant application claims priority to U.S. Provisional Patent Application Ser. No. 61/011,795, filed Jan. 22, 2008, the entire specification of which is expressly incorporated herein by reference.

### FIELD OF THE INVENTION

The present invention relates to an object detection system, and to a method using an algorithm to process three dimensional data imaging for object tracking and ranging; more particularly, the present invention uses a single camera for providing multiple driver assistance services, such as park aid, hitch aid, and liftgate protection.

### BACKGROUND OF THE INVENTION

Vehicle park-aid systems are generally known and are commonly used for the purpose of assisting vehicle operators in parking a vehicle by alerting the operator of potential parking hazards. Typical park-aid systems include ultrasonic or camera systems. Ultrasonic systems can alert the vehicle operator of the distance between the vehicle and the closest particular object. However, ultrasonic systems do not recognize what the objects are and also fail to track multiple objects at the same time. Camera systems can present the vehicle operator with the view from behind the vehicle, however, camera systems do not provide the operator with the distance to the objects viewed and do not differentiate whether or not the viewed objects are within the vehicle operator's field of interest.

Also, the use of multiple three-dimensional imagers for multiple applications is not cost effective. The operations of providing park-aid, hitch-aid, and liftgate protection have been attempted individually, but not by a single system. Also, camera-based environment sensing is unable to alert the driver of objects of interest within the field of view of the camera or three-dimensional imager. The driver must watch the screen and decide which objects present a risk to the vehicle. Non-camera based systems do not provide a view of the environment and don't allow the same visibility provided by a camera system.

Accordingly, there exists a need for a more advanced object detection and ranging system which can filter and process data provided by a three dimensional camera to provide an effective translation of object information to a vehicle operator that can be used in providing assistance to a driver when performing certain tasks, such as parking (i.e. a park aid), attaching a trailer to the hitch of a vehicle (i.e. a hitch aid), or opening and closing a liftgate (i.e. liftgate protection).

### SUMMARY OF THE INVENTION

The present invention is directed to a method of object detection and ranging of objects within a vehicle's field of interest and providing a translation of the object data to a vehicle operator, as well as providing park aid, a hitch aid, and liftgate protection. This is accomplished by providing a camera-based interface that will alert the driver of objects of interest within the field of view while still providing the full view of the environment. An imaging device provides an image of the rearward area outside of a vehicle to a data processor. The processor divides the data into individual rows of pixels for processing, and uses an algorithm which includes assigning each pixel in the rows to an object that was detected by the imaging device; this allows for a real world translation of detected objects and their respective coordinates, including dimensions and distance from the vehicle. The location of the detected objects is available to the vehicle operator to provide a detailed warning of objects within the field of interest.

By aiming the imaging device(s) properly to view the field behind the vehicle, it is possible to perform all the functions mentioned above by a single imaging device system. The operation of the system is determined based on vehicle gear state, liftgate position, liftgate movement, vehicle speed and user input. The functions that the system can perform include, but are not limited to: sensing the environment behind the vehicle and warning the driver through audible or visual feedback of objects; detecting objects in the path of the moving liftgate during opening and closing; warning the driver of potential collisions through audio or visual feedback; and stopping the movement of the liftgate; recognizing a trailer and tracking the position of the trailer relative to vehicle's trailer hitch to aid the driver in the process of maneuvering the vehicle to hooking up the trailer by audible feedback, visual feedback, or a combination of both when backing-up.

The present invention is a system for providing multiple driver assistance services which includes a vehicle having at least one door, and at least one imaging device operable for detecting the presence of one or more objects in proximity to the door for providing all distances between a vehicle and one or more objects in proximity to the vehicle. The imaging device is operable for displaying an image representing the one or more objects.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow diagram depicting a method of operation of an object detection and ranging algorithm, according to the present invention;

FIG. 2 is a flow diagram depicting an algorithm for row processing, according to the present invention;

FIG. 3(a) is a grid illustrating point operations and spatial operations performed on particular pixels, according to the present invention;

FIG. 3(b) is a grid illustrating point operations and spatial operations performed on particular pixels, according to the present invention;

FIG. 4 is a flow diagram illustrating a three dimensional connected components algorithm of FIG. 2, according to the present invention;

FIG. 5 is a flow diagram illustrating a pixel connected components algorithm of FIG. 4, according to the present invention;

FIG. 6 is a flow diagram illustrating an algorithm for merging objects, according to the present invention;

FIG. 7 depicts the present invention being used as a park aid;

FIG. 8 depicts the present invention aiding in the opening and closing of a liftgate;

FIG. 9 depicts the present invention aiding in the attachment of a trailer hitch to a vehicle; and

FIG. 10 is an example of an image produced using the method for object detection, image processing, and reporting, according to the present invention.

### DETAILED DESCRIPTION OF THE PREFERRED EMBODIMENTS

The following description of the preferred embodiment(s) is merely exemplary in nature and is in no way intended to limit the invention, its application, or uses.

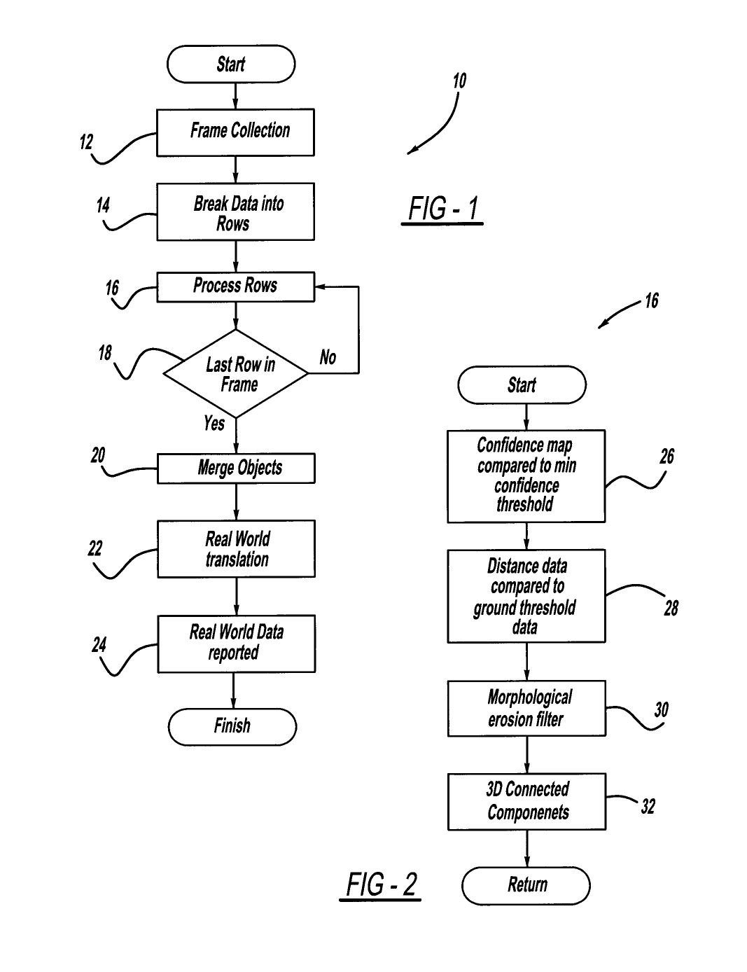

Referring to FIG. 1, a flow diagram depicting a method of using an algorithm for object detection and ranging is shown generally at 10. An imaging device, e.g., a three dimensional imaging camera, generates an image including any objects located outside of a vehicle within the field of interest being monitored, e.g., a generally rearward area or zone behind a vehicle, which will be further described later. A frame of this image is operably collected at a first step 12 by a data processor which divides or breaks the data from the collected frame into groups of rows of pixels at a second step 14. The rows are operably processed at third step 16 by an algorithm, shown in FIG. 2, which includes assigning each pixel in the rows to one or more respective objects in the field of interest. By way of non-limiting example, it could be determined that multiple objects exist within the field of interest. At fourth step 18, the processor determines whether each row has been processed, and processes any remaining rows until all rows are evaluated. At fifth step 20, objects determined to be in such proximity with each other as to be capable of being part of the same object, e.g., a curb, light pole, and the like, are operably merged. At sixth step 22, three-dimensional linear algebra and the like is used to provide a “real world” translation of the objects detected within the field of interest, e.g., to provide object dimensions, coordinates, size, distance from the rear of the vehicle and the like. The real world translation is operably reported to the vehicle operator at seventh step 24. The object detection and ranging method 10 thereby operably alerts the vehicle operator about potential obstacles and contact with each respective object in the field of interest.

Referring to FIGS. 2 to 5 in general, and more specifically to FIG. 2, a flow diagram is depicted illustrating the algorithm for third step 16 in which each row is processed in order to assign each pixel in the rows to an object in the field of interest. The third step 16 generally requires data from the current row, the previous row, and the next row of pixels, wherein the current row can be the row where the current pixel being evaluated is disposed. Typically, the rows of pixels can include data collected from generally along the z-axis, “Z,” extending along the camera's view.

The row processing algorithm shown at 16 generally has four processing steps each including the use of a respective equation, wherein completion of the four processing steps allows the current pixel being evaluated, herein called a “pixel of interest,” to be assigned to an object. A first processing step 26 and a second processing step 28 are threshold comparisons based on different criteria and equations. The first processing step 26 and second processing step 28 can use equation 1 and equation 2 respectfully. A third processing step 30 and a fourth processing steps 32 are spatial operations based on different criteria and equations performed on the pixel of interest. The third processing step 30 and fourth processing step 32 can use equation 3 and equation 4 respectfully. The first and second processing steps 26,28 must be performed before the third and fourth processing steps 30,32 as data from the first and second processing steps 26,28 is required for the third and fourth processing steps 30,32. Outlined below are samples of equations 1 and 2 used in carrying out the first and second processing steps 26,28 respectively and equations 3 and 4 used in carrying out the third and fourth processing steps 30,32 respectively.

$$\begin{matrix}{Z}_{( r + 1 , c + 1 )} = \{ \begin{matrix}O : {Confidence}_{( r + 1 , c + 1 )} < ConfidenceThreshold \\ {Z}_{( r + 1 , c + 1 )} : otherwise\end{matrix} \\ Where Confidence Threshold can be a predetermined constant & Equation 1 \\ {Z}_{( r + 1 , c + 1 )} = \{ \begin{matrix}O : {Z}_{( r + 1 , c + 1 )} > {GroundThreshold}_{( r + 1 , c + 1 )} \\ {Z}_{( r + 1 , c + 1 )} : otherwise\end{matrix} \\ Where Ground Threshold can be a pixel mapped threshold . & Equation 2 \\ {Z}_{( r , c )} = \{ \begin{matrix}{Z}_{( r , c )} : {Z}_{( r , c + 1 )} , {Z}_{( r + 1 , c + 1 )} > 0 \\ O : otherwise\end{matrix} \\ Where ( r , c ) is a pixel of interest & Equation 3 \\ {Obj}_{( r , c )} = \{ \begin{matrix}{Obj}_{( r + i , c + j )} : \vert {Z}_{( r , c )} - {Z}_{( r + i , c + j )} \vert < MIN\_DIST \\ NewObjAssignment : ( {Obj}_{( r + i , c + j )} = invalid \vert \vert \vert {Z}_{( r , c )} - {Z}_{( r + i , c + j )} \vert > MIN\_DIST ) \\ \& {Obj}_{( r , c )} = unassigned \\ invalid : {Z}_{( r , c )} = 0 \\ {Obj}_{( r , j )} : otherwise\end{matrix} \\ Where i , j = ( - 1 , 1 ) \\ {Obj}_{( r , c )} is an object to which the pixel of interest was assigned . \\ ( r , c ) is a pixel of interest . & Equation 4\end{matrix}$$

The first and second processing steps 26,28 are generally filtering or point based operations which operate on a pixel disposed one row ahead and one column ahead of the pixel of interest being evaluated for assignment to an object. The first processing step 26 uses equation 1 and includes comparing a confidence map to a minimum confidence threshold. The first processing step 26 determines a confidence factor for each pixel of the collected frame to show reliability of the pixel data collected along the z-axis. The confidence factor is compared to a static threshold, e.g., a predetermined constant, and the data is filtered. The second processing step 28 uses equation 2 and includes comparing distance data to ground threshold data. The second processing step 28 compares the data, e.g., pixel data, collected along the z-axis to a pixel map of a surface, e.g., the ground surface rearward of the vehicle upon which the vehicle travels. This allows the surface, e.g., ground surface, in the captured image to be filtered out or ignored by the algorithm. It is understood that additional surfaces or objects, e.g., static objects, the vehicle bumper, hitch, rear trim, and the like, can be included in the pixel map of the surface such that they too can be filtered out or discarded by the algorithm.

The third and fourth processing steps 30,32 are generally spatial operations or processes performed on the pixel of interest in order to assign the pixel of interest to an object. The third processing step 30 uses equation 3 and is a morphological erosion filter used to eliminate and discard single pixel noise, e.g., an invalid, inaccurate, unreliable, and the like pixel of interest. This step requires that the data in the forward adjacent pixels, e.g., r+m, c+n, of the collected frame be present and valid in order for the pixel of interest to be valid. The fourth processing step 32 uses equation 4 and includes a three dimensional (“3D”) connected components algorithm which groups together objects based on a minimum distance between the z-axis data of the pixel of interest and the z-axis data of pixels adjacent to the pixel of interest which have already been assigned to objects. The 3D connected components algorithm requires that the pixel of interest be compared to the backward pixels, e.g., r-m, c-n. Equation 4 can depict the result of the algorithm, however, it is understood that the implementation can differ. By way of non-limiting example, equation 4 can ignore the merging of objects, e.g., of step 20, and assign pixels of interest to new objects and re-assign the pixels if necessary.

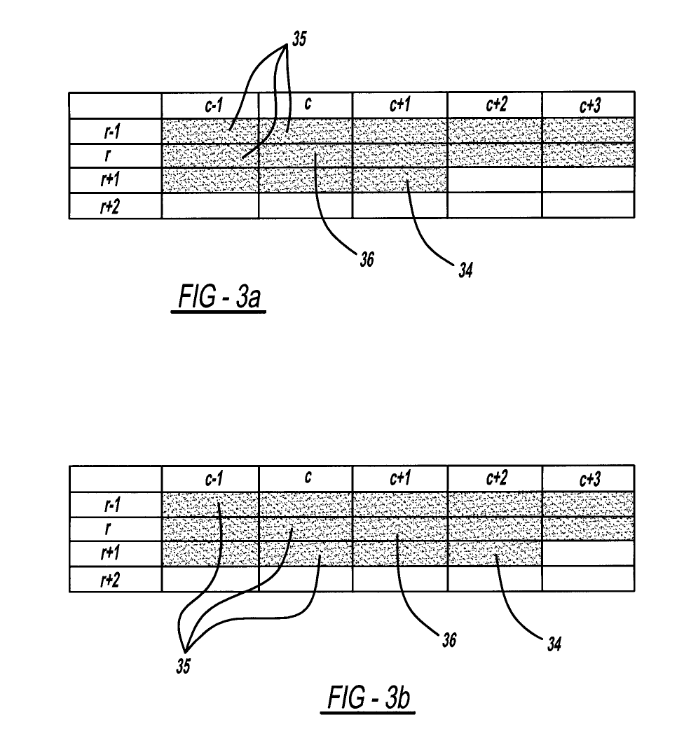

FIGS. 3(a) and 3(b) each show an example of a pixel that is being filtered, shown at 34, using the first and second processing steps 26,28, and a pixel of interest, shown at 36, that is being assigned to an object using the third and fourth processing steps 30,32. By way of non-limiting example, FIGS. 3(a) and 3(b) each depict a two-dimensional grid with squares representing pixels in which the pixels have been divided into groups of rows of pixels, by step 14, having four rows and five columns. Referring to FIG. 3(a), a pixel of interest, shown at 36, is disposed at a row, “r”, and at column, “c.” The pixel being filtered, shown at 34, is disposed one row ahead, “r+1”, and one column ahead, “c+1”, of the pixel of interest at r,c. Pixels shown at 35 illustrate pixels that have gone through filtering operations using the first and second processing steps 26,28. Referring to FIG. 3(b), a pixel of interest, shown at 36, is disposed at a row, “r”, and at column, “c+1.” The pixel being filtered, shown at 34, is disposed one row ahead, “r+1”, and one column ahead, “c+2”, of the pixel of interest at r,c+1. Pixels shown at 35 illustrate pixels that have gone through filtering operations using the first and second processing steps 26,28. For example, the illustrated pixels of interest disposed at r,c and r,c+1 respectively may be assigned to one or more objects in the field of interest upon completion of the spatial operations of the third and fourth processing steps 30,32.

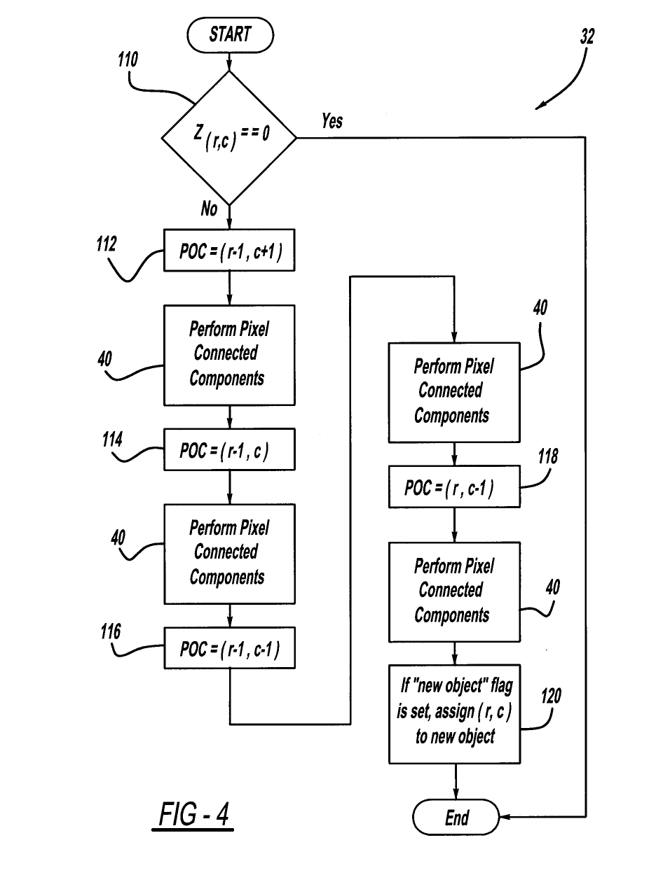

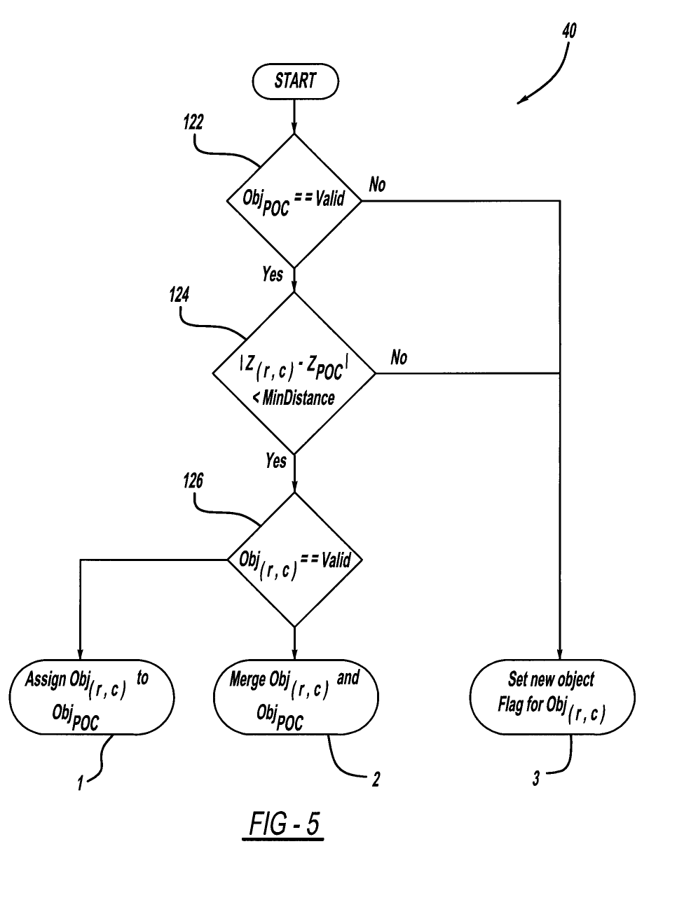

Referring generally to FIGS. 2 and 4, and specifically to FIG. 4, there is depicted a flow chart diagram for the 3D connected components algorithm, shown generally at 32. In general, row processing steps one through three 26, 28, and 30 (shown in FIG. 2) should be performed before conducting the 3D connected components 32 algorithm. This allows a pixel of interest to be compared only with pixels that have already been assigned to objects. By way of non-limiting example, the pixel of interest, shown as “(r,c)” is disposed at row “r” and column “c.” At step 110, if and only if the depth data for the pixel of interest, “Z(r,c),” is zero, then proceed to step 18 of the object detection and ranging algorithm 10 (shown in FIG. 1). If the depth data for the pixel of interest, “Z(r,c),” is not zero, then proceed to step 112. By way of non-limiting example, a pixel of comparison (“POC”), shown as “POC” in FIG. 4, is disposed at row “r-1” and column “c+1” and a pixel connected components algorithm 40 is performed (shown in the flow chart diagram of FIG. 5). At step 114, the pixel of comparison is disposed at r-1 and c and the pixel connected components algorithm 40 depicted in FIG. 5 is performed. At step 116, the pixel of comparison is disposed at r-1 and c-1 and the pixel connected components algorithm 40 depicted in FIG. 5 is performed. At step 118, the pixel of comparison is disposed at r and c-1 and the pixel connected components algorithm 40 depicted in FIG. 5 is performed. If performance of this last pixel connected components algorithm 40 sets a new object flag for the object to which the pixel of interest was assigned, “Obj(r,c)”, then at step 120 the pixel of interest, “(r,c)”, is assigned to a new object. The object detection and ranging algorithm 10 then determines at decision 18 if the last row in the frame has been processed. As illustrated in FIG. 4, the pixel connected components algorithm 40 can be performed four times for each pixel of interest before moving on to the next pixel of interest to be evaluated. It is understood that the 3D connected components algorithm 32 can help provide a translation of the field of interest relative to a vehicle including tracking of multiple objects and providing information including distance, dimensions, geometric centroid and velocity vectors and the like for the objects within the field of interest.

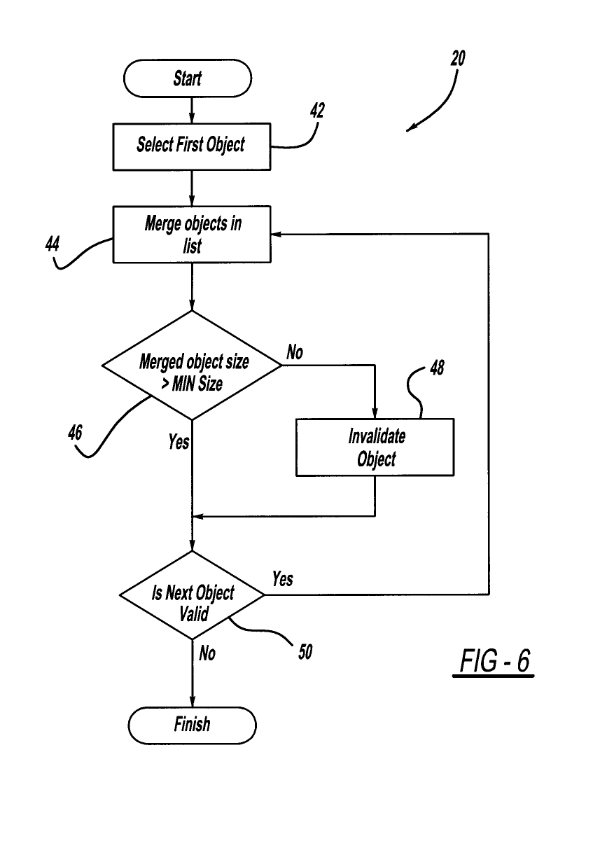

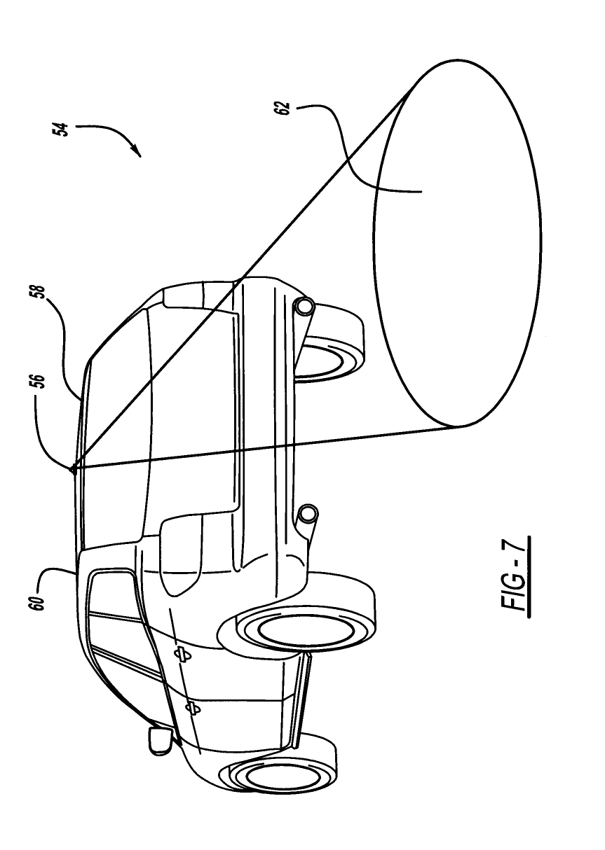

Referring generally to FIGS. 4 and 5, and specifically to FIG. 5, there is depicted a flow chart diagram for the pixel connected components algorithm, shown generally at 40. In general, through the pixel connected components algorithm 40, pixels can be grouped into three states 1,2,3. The first state 1 typically assigns the object to which the pixel of interest was assigned, “Obj(r,c)”, to the object to which the pixel of comparison is also assigned “Obj(POC)”. The second state 2 typically merges the object to which the pixel of interest was assigned with the object to which the pixel of comparison was assigned. By way of non-limiting example, where it is determined that pixels assigned to objects substantially converge in relation to the z-axis as the axis nears the imaging device, the pixels can be merged as one object (depicted in the flow chart diagram of FIG. 6). The third state 3 typically sets a new object flag for the object to which the pixel of interest was assigned, e.g., at least preliminarily notes the object as new if the object cannot be merged with another detected object. It is understood that the objects to which the respective pixels of interest are assigned can change upon subsequent evaluation and processing of the data rows and frames, e.g., objects can be merged into a single object, divided into separate objects, and the like.

At first decision 122 of the pixel connected components algorithm 40, if and only if the object to which a pixel of comparison was assigned is not valid, e.g., deemed invalid by third processing step 30, not yet assigned, is pixel noise, and the like, then a new object flag is set for the object to which the pixel of interest, (“r,c”), was assigned at State 3. If the object to which a pixel of comparison was assigned is valid, then second decision 124 is performed. At second decision 124, if the depth data for the pixel of interest, “Z(r,c)”, minus the depth data for the pixel of comparison, “Z(POC)” is less than the minimum distance, then third decision 126 is performed, e.g., minimum distance between the z-axis data of the pixel of interest and the z-axis data of pixels adjacent to the pixel of interest. If not, then the object to which the pixel of interest was assigned is set or flagged as new at state 1. At third decision 126, if and only if the object to which the pixel of interest was assigned is valid, then the processor either selectively assigns the object to which the pixel of interest was assigned to the object to which the object to with the pixel of comparison was assigned at state 1, or selectively merges the object to which the pixel of interest was assigned with the object to which the pixel of comparison was assigned at state 2 (shown in FIG. 6).

Referring to FIG. 1, the processor determines whether each row has been processed at fourth step 18 and repeats the third and fourth steps 16,18 until all of the rows are processed. Once all of the rows are processed the object data that each pixel was assigned to represents all objects detected along the camera's view, e.g., one or more objects detected. These objects can be merged at fifth step 20, wherein objects that are determined to be in operable proximity with each other as to be capable of being part of the same object are operably merged. It is understood that objects that were detected as separate, e.g., not in proximity with each other, during a first sweep or collection of a frame of the imaging device can be merged upon subsequent sweeps if it is determined that they operably form part of the same object.

Referring to FIG. 6, a flow diagram illustrating an algorithm for merging objects, is shown generally at 20, e.g., merging objects to combine those that were initially detected as being separate. In general, the object to which the pixel of interest object was assigned and the object to which the pixel of comparison was assigned can be merged. By way of non-limiting example, where it is determined that pixels assigned to objects substantially converge in relation to the z-axis as the axis nears the imaging device during a single or multiple sweeps of the field of interest by the imaging device, the pixels can be merged as one object. At first merge step 42, the data processor selects a first object, e.g., an object to which the pixel of interest was assigned. At second merge step 44, the first object is selectively merged with a detected or listed object, e.g., an object to which respective pixels of interest are assigned, to selectively form a merged object. At third merge decision 46, if the size of a respective merged object is not greater than the minimum size of the first object, then the first object is invalidated at invalidation step 48, e.g., the first object will not be considered as being in such proximity with that particular detected or listed object as to be capable of being part of the same object. If the size of a respective merged object is greater than the minimum size of the first object, then fourth merge decision 50 is performed. At fourth merge decision 50, if the next object to which a respective pixel of comparison is assigned is valid, then perform the second and third merge steps 44,46. If at fourth merge decision 50 the next object to which a respective pixel of comparison is assigned is not valid, then the algorithm for merging objects, shown generally at 20, is ended and the real world translation at fifth step 22 is performed (shown in FIG. 1).

Referring to FIG. 1, at sixth step 22, three-dimensional linear algebra and the like is used to provide the real world translation of the objects detected within the field of interest, e.g., object dimensions, location, distance from the vehicle, geometric centroid, velocity vectors, and the like, and combinations thereof, is performed and communicated to the vehicle's operator. This real world translation is operably reported to the vehicle operator at seventh step 24 to provide a detailed warning of all objects to thereby alert the vehicle operator about potential obstacles and contact with each respective object in the field of interest.

The ability to depict various objects in proximity to the vehicle has many types of applications, such as aiding the driver of the vehicle in parking (park aid), aiding in the attachment of a hitch to the rear of the vehicle (hitch aid), and protecting the liftgate from contacting objects when opening (liftgate protection). FIGS. 7-9 show how the three applications mentioned above can be performed using a single system in a central location, which may incorporate the method described in FIGS. 1-6. In the actual implementation, multiple cameras maybe necessary to collect the entire field of view, however each camera will function in all three applications.

Referring to FIG. 7, the park aid application with the highlighted area showing the detection zone of the system of the present invention is designated generally at 54. In this particular embodiment, an imaging device, such as a camera 56, is shown attached to the deck lid 58 of a vehicle 60. The camera 56 is able to detect objects in a detection zone 62. Objects which fall into the detection zone 62 as the vehicle 60 backs up, or objects that move towards the vehicle 60 will be evaluated by the park aid algorithm and reported to the driver through the method decided in the implementation, such as the methods described above.

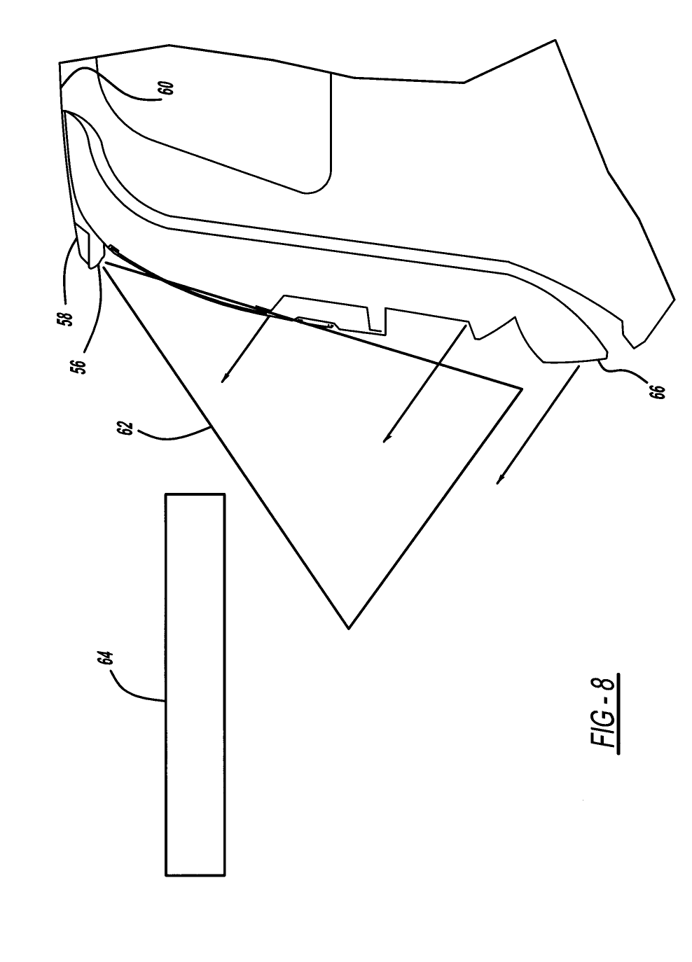

FIG. 8 shows the lift gate protection application of the present invention. A smaller area of the detection zone 62 collected during park aid operation is considered and if any objects, represented by the box 64 in FIG. 8, enter the detection zone 62 during the movement of the liftgate 66 (and camera 56), the objects 64 are either reported to the driver or the movement of the liftgate 66 is halted or reversed.

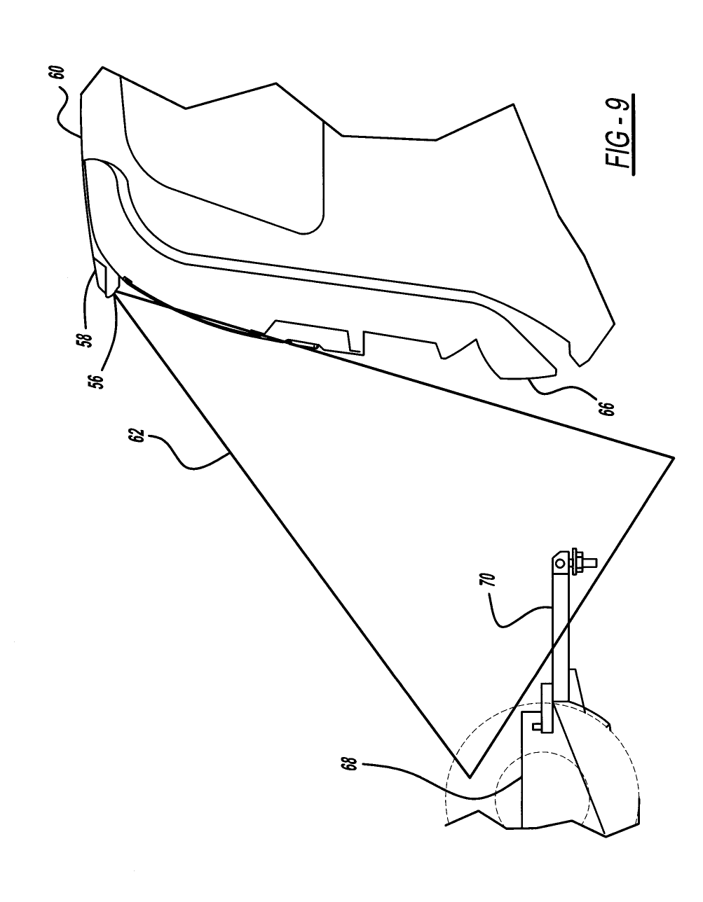

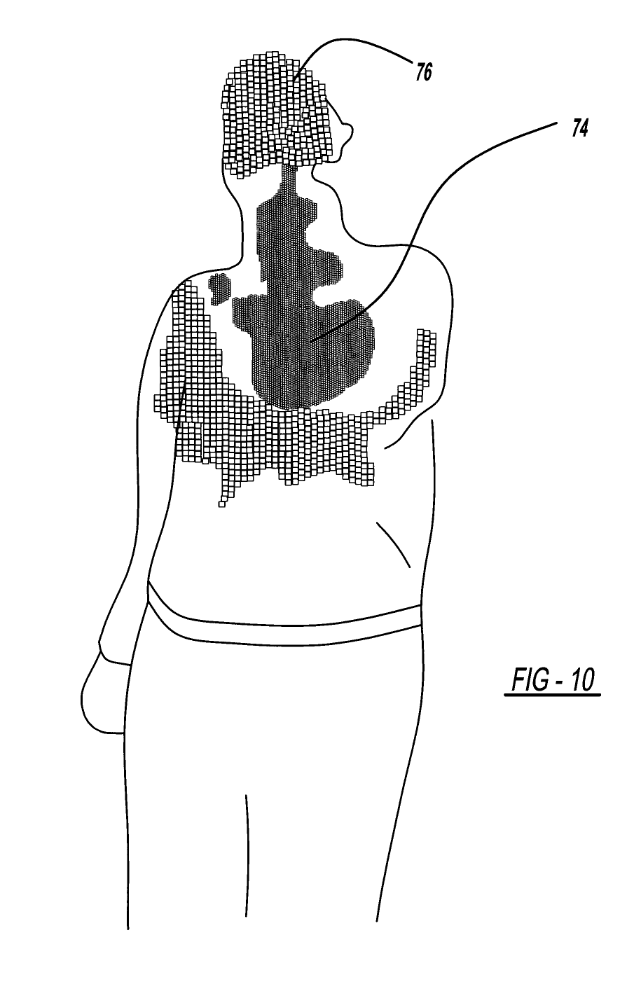

FIG. 9 shows the operation of aiding the attachment of a trailer 68. The trailer 68 includes a hitch 70 which is selectively attached to a hitch (not shown) of the vehicle 60. The system searches the detection zone 62 and detects the trailer 68 in the detection zone 62, the system also locates the hitch attached to the vehicle 60 and calculates the trajectory required by the vehicle 60 to align the trailer hitch of the vehicle with the hitch 70. This trajectory is then recommended to the driver through the method decided in this implementation, such as one of the methods described above.

The camera 56 provides all of the information to the driver on a display as a monochrome image 72, shown in FIG. 10, or somehow dulled to allow highlighted images to stand out. This allows the driver to see objects within the field of view that are not recognized by the detection algorithm or not deemed to be of interest by the system using the algorithm described above with respect to FIGS. 1-6. Objects within this image 72 which are determined to be of interest are then highlighted in some way to indicate that they are objects the driver must be aware of. This highlighting can be a solid color superimposed on the monochrome image, providing the full color representation of the object (if available) or any other way to differentiate the object from the background. In the embodiment shown in FIG. 10, pixels 74,76 are provided in multiple colors, showing the change in distance between the various objects in the image 13.

The image 72 from the camera 56 is collected by a suitable digital signal processor (DSP) and is processed by an object detection algorithm (as described above) or some filtering process to find objects of interest to the driver. The raw data is then converted to a monochrome image (if necessary). The objects found by the DSP are then highlighted according to distance in the given image using the pixels similar to the pixels 74,76 shown in FIG. 10, allowing them to stand out to the driver/audience without the driver needing to study the image 72 and allowing additional information to be available if desired.

The system provides several advantages. The system is used for interpolation of distance into varying colors of the pixels 72,74 in a fashion that provides for variable driver warning within a distance measuring and imaging system. The system can be integrated into the rear end of the vehicle 60. The camera 56 is not limited to being integrated with the deck lid 58, as described above, but could also be integrated with the light gate, spoiler, or fascia. The system senses objects entering the area of interest behind the vehicle 60 and warns the driver through audible, visual or both indicators when backing-up. Additionally, the system senses objects on the path of the power lift gate 66 as the liftgate 66 swings up or down and prevents the liftgate 66 from touching the objects on its path. Also, the system recognizes a trailer 68 and tracks the position of the vehicle 60 relative to the trailer hitch 70 and aids the driver in the process of maneuvering the vehicle while hooking up the trailer 68 by audible, visual or both indicators when backing-up.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for providing multiple driver assistance services, comprising:
a vehicle having at least one door; and
at least one imaging device operable for detecting the presence of one or more objects in proximity to said door for providing all distances between a vehicle and one or more objects in proximity to said vehicle, said at least one imaging device being operable for displaying an image representing said one or more objects.

2. The system for providing multiple driver assistance services of claim 1, further comprising at least one detection zone, wherein said at least one imaging device is operable to detect said one or more objects in said at least one detection zone.

3. The system for providing multiple driver assistance services of claim 2, said image representing said one or more objects in said at least one detection zone, indicative of the distance between said one or more objects and said at least one door.

4. The system for providing multiple driver assistance services of claim 1, further comprising a digital signal processor operable with an object detection algorithm for collecting said image produced by said imaging device.

5. The system for providing multiple driver assistance services of claim 4, wherein said digital signal processor and said object detection algorithm are operable for dividing said image into a plurality of pixels.

6. The system for providing multiple driver assistance services of claim 5, further comprising each of said plurality of pixels being designated a specific color, said plurality of pixels being divided into one or more groups of pixels, each of said one or more groups of pixels having substantially similar colors.

7. The system for providing multiple driver assistance services of claim 6, said each of said one or more groups of pixels having a substantially similar color being operable for providing an indication of the location of said one or more objects in relation to said at least one door of said vehicle.

8. The system for providing multiple driver assistance services of claim 4, wherein one of said multiple driver assistance services is a park aid, comprising:
said at least one door further comprising a liftgate; and
wherein as said one or more objects enters said at least one detection zone during the movement of said liftgate, said digital signal processor and said object detection algorithm are operable to perform one selected from the group consisting of reporting the position of said one or more objects to a user of said vehicle, halting the movement of said liftgate, reversing the movement of said liftgate, and combinations thereof.

9. The system for providing multiple driver assistance services of claim 4, wherein one of said multiple driver assistance services is aiding in the attachment of a trailer to said vehicle, comprising:
a trailer; and
a hitch connected to said trailer, said hitch being operable for connection with said vehicle, wherein as said hitch moves in said at least one detection zone as said vehicle moves towards said trailer, said digital signal processor and said object detection algorithm are operable for calculating the trajectory required for said vehicle to properly align with said hitch.

10. The system for providing multiple driver assistance services of claim 1, wherein said at least one imaging device is connected to component of said vehicle, said component selected from the group consisting of a light gate, a deck lid, a spoiler, a fascia, and combinations thereof.

11. A system for providing multiple driver assistance services, comprising:
a vehicle having at least one door which is moveable between an open position and a closed position;
at least one imaging device used for detecting the presence of various objects in proximity to said door; and
a detection zone, said at least one imaging device being operable for detecting one or more objects in said detection zone, for providing an indication of the position of said one or more objects in relations to said vehicle.

12. The system for providing multiple driver assistance services of claim 11, further comprising an image operable for being displayed by said at least one imaging device, said image representing said one or more objects in said detection zone.

13. The system for providing multiple driver assistance services of claim 12, further comprising a digital signal processor operable with an object detection algorithm for collecting said image produced by said imaging device, wherein said digital signal processor and said object detection algorithm are operable for dividing said image into a plurality of pixels.

14. The system for providing multiple driver assistance services of claim 13, wherein each of said plurality of pixels is designated to be a specific color, wherein said plurality of pixels are divided into one or more groups of pixels.

15. The system for providing multiple driver assistance services of claim 14, wherein each of said one or more groups of pixels are of substantially similar colors.

16. The system for providing multiple driver assistance services of claim 15, wherein each of said one or more groups of pixels having a substantially similar color provide an indication of the location of said one or more objects in said detection zone in proximity to said vehicle.

17. The system for providing multiple driver assistance services of claim 13, wherein one of said multiple driver assistance services is a park aid, comprising:
said at least one door further comprising a liftgate; and
wherein as said one or more objects enters said detection zone during the movement of said liftgate, said digital signal processor and said object detection algorithm are operable to perform one selected from the group consisting of reporting the position of said one or more objects to a user of said vehicle, halting the movement of said liftgate, reversing the movement of said liftgate, and combinations thereof.

18. The system for providing multiple driver assistance services of claim 13, wherein one of said multiple driver assistance services is aiding in the attachment of a trailer to said vehicle, comprising:
a trailer; and
a hitch connected to said trailer, said hitch being operable for connection with said vehicle, wherein as said hitch moves in said detection zone as said vehicle moves towards said trailer, said digital signal processor and said object detection algorithm are operable for calculating the trajectory required for said vehicle to properly align with said hitch.

19. The system for providing multiple driver assistance services of claim 11, wherein said at least one imaging device is connected to a component of said vehicle, said component selected from the group consisting of a light gate, a deck lid, a spoiler, a fascia, and combinations thereof.

20. A system for providing multiple driver assistance services, comprising:
a vehicle having at least one door which is moveable between an open position and a closed position, and any position therebetween;
at least one imaging device used for detecting the presence of various objects in proximity to said door;
a detection zone, said at least one imaging device being operable for detecting one or more objects in said detection zone; and
an image displayed by said at least one imaging device, said image representing said one or more objects in said detection zone, thereby indicating to a user of said vehicle where said one or more objects are in proximity to said at least one door.

21. The system for providing multiple driver assistance services of claim 20, further comprising a digital signal processor operable with an object detection algorithm for collecting said image produced by said imaging device, and dividing said image into a plurality of pixels.

22. The system for providing multiple driver assistance services of claim 21, wherein one of said multiple driver assistance services is a park aid, comprising:
said at least one door further comprising a liftgate; and
wherein as said one or more objects enters said detection zone during the movement of said liftgate, said digital signal processor and said object detection algorithm are operable to perform one selected from the group consisting of reporting the position of said one or more objects to a user of said vehicle, halting the movement of said liftgate, reversing the movement of said liftgate, and combinations thereof.

23. The system for providing multiple driver assistance services of claim 21, wherein one of said multiple driver assistance services is aiding in the attachment of a trailer to said vehicle, comprising:
a trailer; and
a hitch connected to said trailer, said hitch being operable for connection with said vehicle, wherein as said hitch moves in said detection zone as said vehicle moves towards said trailer, said digital signal processor and said object detection algorithm are operable for calculating the trajectory required for said vehicle to properly align with said hitch.

24. The system for providing multiple driver assistance services of claim 21, wherein each of said plurality of pixels is of a specific color, and said plurality of pixels are divided into one or more groups of pixels, each of said one or more groups of pixels having substantially similar colors.

25. The system for providing multiple driver assistance services of claim 24, wherein each of said one or more groups of pixels having a similar color provide an indication of the location of each of said one or more objects in said detection zone in proximity to said vehicle.

26. The system for providing multiple driver assistance services of claim 20, wherein said at least one imaging device is connected to a component of said vehicle, said component selected from the group consisting of a light gate, a deck lid, a spoiler, a fascia, and combinations thereof.
